(19) United States
(12) Patent Application Publication
(10) Pub. No.: US 2024/0302564 A1
(43) Pub. Date: Sep. 12, 2024

(54) A METHOD AND SYSTEM FOR MODELING CARBONATE CEMENTATION IN FORWARD DEPOSITIONAL MODELS

(71) Applicant: SAUDI ARABIAN OIL COMPANY, Dhahran (SA)

(72) Inventors: Xiaoxi Wang, Beijing (CN); Peng Lu, Dhahran (SA); Rainer Zuhlke, Dhahran (SA)

(73) Assignees: SAUDI ARABIAN OIL COMPANY, Dhahran (SA); ARAMCO FAR EAST (BEIJING) BUSINESS SERVICES CO., LTD., Beijing (CN)

(21) Appl. No.: 18/245,835

(22) PCT Filed: May 31, 2022
(86) PCT No.: PCT/CN2022/096231

§ 371 Date: Mar. 17, 2023

(51) Int. Cl. G01V 20/00; E21B 7/04; E21B 49/08; G06F 30/28

(52) U.S. Cl. CPC G01V 20/00; E21B 7/04; E21B 49/087; G06F 30/28; E21B 2200/20

(57) ABSTRACT

A method related to generating a facies-cement model of a subsurface region. The method includes obtaining depositional data regarding the subsurface region, wherein the depositional data incudes wave impact data. The method further includes generating, by a computer processor, a geological model for the subsurface region using a forward-depositional modeling process and the depositional data, wherein the geological model comprises wave energy data. The method further includes determining, by the computer processor, carbonate cementation data for the subsurface region using a diagenetic modeling process and the wave energy data, wherein the carbonate cementation data describes cementation in one or more depositional processes, and generating, by the computer processor, a facies-cement model of the subsurface region.

### BACKGROUND

Oil and gas extraction from subsurface rock formations requires the drilling of wells using drilling rigs mounted on the ground or on offshore rig platforms. Once drilled, the wells access the hydrocarbon reservoirs. Reservoir quality, among other things, considers the hydrocarbon storage capacity, the hydrocarbon deliverability, and the heterogeneity of the reservoir. Identification of reservoir locations and accurate estimation of reservoir quality is critical for exploration and production in the oil and gas industry.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed relate to a method. The method includes obtaining depositional data regarding the subsurface region, wherein the depositional data incudes wave impact data. The method further includes generating, by a computer processor, a geological model for the subsurface region using a forward-depositional modeling process and the depositional data, wherein the geological model comprises wave energy data. The method further includes determining, by the computer processor, carbonate cementation data for the subsurface region using a diagenetic modeling process and the wave energy data, wherein the carbonate cementation data describes cementation in one or more depositional processes, and generating, by the computer processor, a facies-cement model of the subsurface region.

In general, in one aspect, embodiments disclosed relate to a system. The system includes a plurality of wells coupled to a subsurface region, and a reservoir simulator. The reservoir simulator includes a computer processor which is coupled to the plurality of wells. The reservoir simulator includes functionality for obtaining depositional data regarding the subsurface region, wherein the depositional data comprises wave impact data. The reservoir simulator further includes functionality for generating a geological model for the subsurface region using a forward-depositional modeling process and the depositional data, wherein the geological model comprises wave energy data. The reservoir simulator further includes functionality for determining carbonate cementation data for the subsurface region using a diagenetic modeling process and the wave energy data, wherein the carbonate cementation data describes cementation in one or more depositional processes. The reservoir simulator further includes functionality for generating a facies-cement model of the subsurface region.

In general, in one aspect, embodiments disclosed relate to a non-transitory computer readable medium storing instructions executable by a computer processor. The instructions include functionality for obtaining depositional data regarding a subsurface region, wherein the depositional data comprises wave impact data. The instructions further include functionality for generating a geological model for the subsurface region using a forward-depositional modeling process and the depositional data, wherein the geological model comprises wave energy data. The instructions further include functionality for determining carbonate cementation data for the subsurface region using a diagenetic modeling process and the wave energy data, wherein the carbonate cementation data describes cementation in one or more depositional processes. The instructions further include functionality for generating a facies-cement model of the subsurface region.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts elements of a well environment in accordance with one or more embodiments.

FIG. 2 depicts carbonate depositional environments in accordance with one or more embodiments.

FIG. 3 shows functional relationships between wave energy, carbonate facies type, and cementation in accordance with one or more embodiments.

FIG. 4 shows cementation functions in accordance with one or more embodiments.

FIG. 5 shows a flowchart in accordance with one or more embodiments.

FIG. 6 shows a system in accordance with one or more embodiments.

FIG. 7A shows a facies model in accordance with one or more embodiments.

FIG. 7B shows a facies-cement model in accordance with one or more embodiments.

FIG. 7C shows a porosity model in accordance with one or more embodiments.

FIG. 7D shows an updated porosity model in accordance with one or more embodiments.

FIG. 8 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods that use forward-depositional modeling to produce a particular facies model, such as a 3D facies-cement model. For example, a reservoir simulator may receive various inputs from data sources such as initial bathymetry data, subsidence history data, sea-level changes data, sediment type data, carbonate production data, and wave impact data. The reservoir simulator may use this input data to produce a model that describes various sediment proportions, facies distributions and/or categorizations, wave energy or fluid velocity, and bathymetry. Furthermore, diagenetic modeling is used to determine a prediction of carbonate cement abundance and the rate of carbonate cementation in a subsurface region. For example, cementation rate may be a function of flow velocity, where flow velocity may be determined by wave energy. As different carbonate facies receive different wave energies, various empirical relationships may be used to identify various carbonate facies between the cementation distribution (e.g., based on diagenetic modeling) and the wave energy (e.g., as an input parameter in depositional modeling). Accordingly, a facies-cement model may be generated that provides quantitative 3D models of depositional architecture, internal lithofacies heterogeneity and reservoir properties.

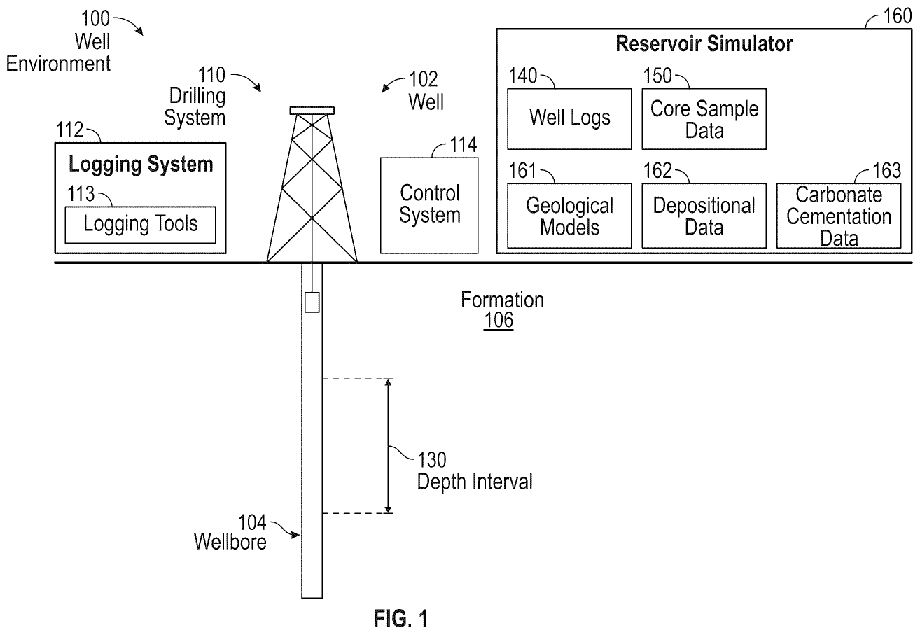

Turning to FIG. 1, FIG. 1 shows a schematic diagram in accordance with one or more embodiments. As shown, FIG. 1 illustrates a well environment (100) that may include a well (102) having a wellbore (104) extending into a formation (106). The wellbore (104) may include a bored hole that extends from the surface into a target zone of the formation (106), such as a reservoir. The formation (106) may include various formation characteristics of interest, such as formation porosity, formation permeability, resistivity, density, water saturation, and the like. Porosity may indicate how much space exists in a particular rock within an area of interest in the formation (106), where oil, gas, and/or water may be trapped. Permeability may indicate the ability of liquids and gases to flow through the rock within the area of interest. Resistivity may indicate how strongly rock and/or fluid within the formation (106) opposes the flow of electrical current. For example, resistivity may be indicative of the porosity of the formation (106) and the presence of hydrocarbons. More specifically, resistivity may be relatively low for a formation that has high porosity and a large amount of water, and resistivity may be relatively high for a formation that has low porosity or includes a large amount of hydrocarbons. Water saturation may indicate the fraction of water in a given pore space.

Keeping with FIG. 1, the well environment (100) may include a reservoir simulator (160) and various well systems, such as a drilling system (110), a logging system (112), a control system (114), and a well completion system (not shown). The drilling system (110) may include a drill string, drill bit, a mud circulation system and/or the like for use in boring the wellbore (104) into the formation (106). The control system (114) may include hardware and/or software for managing drilling operations and/or maintenance operations. For example, the control system (114) may include one or more programmable logic controllers (PLCs) that include hardware and/or software with functionality to control one or more processes performed by the drilling system (110). Specifically, a programmable logic controller may control valve states, fluid levels, pipe pressures, warning alarms, and/or pressure releases throughout a drilling rig. In particular, a programmable logic controller may be a ruggedized computer system with functionality to withstand vibrations, extreme temperatures, wet conditions, and/or dusty conditions, for example, around a drilling rig. Without loss of generality, the term “control system” may refer to a drilling operation control system that is used to operate and control the equipment, a data acquisition and monitoring system that is used to acquire equipment data and to monitor one or more well operations, or a well interpretation software system that is used to analyze and understand well events, such as drilling progress. A logging system may be similar to a control system with a specific focus on managing one or more logging tools.

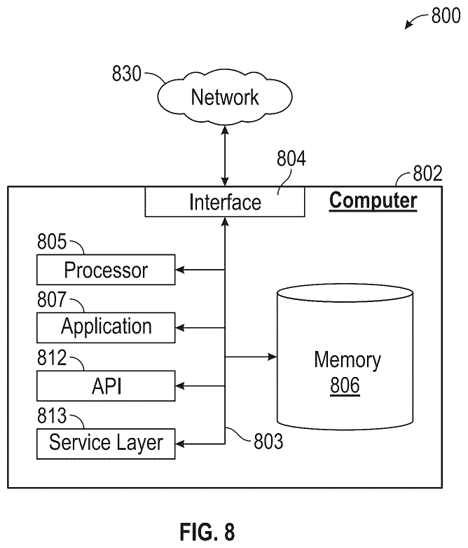

Turning to the reservoir simulator (160), a reservoir simulator (160) may include hardware and/or software with functionality for storing and/or analyzing well logs (140), core sample data (150), geological models (161), depositional data (162), carbonate cementation data (163), seismic data, and/or other types of data to determine reservoir properties regarding one or more geological regions. While the reservoir simulator (160) is shown at a well site, in some embodiments, the reservoir simulator (160) may be remote from a well site. In some embodiments, the reservoir simulator (160) is implemented as part of a software platform for the control system (114). The software platform may obtain data acquired by the drilling system (110) and logging system (112) as inputs, which may include multiple data types from multiple sources. The software platform may aggregate the data from these systems (110, 112) in real time for rapid analysis. In some embodiments, the control system (114), the logging system (112), the reservoir simulator (160), and/or a user device coupled to one of these systems may include a computer system that is similar to the computer system (802) described below with regard to FIG. 8 and the accompanying description.

With respect to geological models, geological models may include depositional models, geochemical models, or geomechanical models that describe structural relationships within a particular geological region. Likewise, a geological model may identify one or more rock types associated with one or more geological regions (e.g., formation (106)). Examples of rock types may include one or more depositional rock types (e.g., where a geological region is based on a depositional environment), rock types that include similar diagenetic processes, rock types based on similar geological trends, and/or rock types based on similar reservoir properties. For example, a rock type may correspond to an irreducible water saturation, residual oil saturations, rock permeability, capillary pressure, maximum capillary pressure heights, relative permeabilities, and rock classes. Likewise, rock types may be based on static reservoir properties as well as dynamic reservoir properties.

The logging system (112) may include one or more logging tools (113) for use in generating well logs of the formation (106). For example, a logging tool may be lowered into the wellbore (104) to acquire measurements as the tool traverses a depth interval (130) (e.g., a targeted reservoir section) of the wellbore (104). The plot of the logging measurements versus depth may be referred to as a “well log”. Well logs (140) may provide depth measurements of the well (104) that describe such reservoir characteristics as formation porosity, formation permeability, resistivity, water saturation, and the like. The resulting logging measurements may be stored and/or processed, for example, by the control system (114), to generate corresponding well logs for the well (102). A well log (140) may include, for example, a plot of a logging response time versus true vertical depth (TVD) across the depth interval (130) of the wellbore (104).

Turning to coring, reservoir characteristics may be determined using core sample data (e.g., core sample data (150)) acquired from a well site. For example, certain reservoir characteristics can be determined via coring (e.g., physical extraction of rock specimens) to produce core specimens and/or logging operations (e.g., wireline logging, logging-while-drilling (LWD) and measurement-while-drilling (MWD)). Coring operations may include physically extracting a rock specimen from a region of interest within the wellbore (104) for detailed laboratory analysis. For example, when drilling an oil or gas well, a coring bit may cut core plugs (or “cores” or “core specimens” or “core samples”) from the formation (106) and bring the core plugs to the surface, and these core specimens may be analyzed at the surface (e.g., in a lab) to determine various characteristics of the formation (106) at the location where the specimen was obtained. In some embodiments, natural gamma rays are also routinely measured on acquired core samples, such as for depth matching with borehole gamma-ray logs and for correlation with other accurate high-spatial-resolution (HSR) studies on the cores (e.g., computerized tomography (CT), nuclear magnetic resonance (NMR), and X-ray fluorescence (XRF)).

Turning to various coring technique examples, conventional coring may include collecting a cylindrical specimen of rock from the wellbore (104) using a core bit, a core barrel, and a core catcher. The core bit may have a hole in its center that allows the core bit to drill around a central cylinder of rock. Subsequently, the resulting core specimen may be acquired by the core bit and disposed inside the core barrel. More specifically, the core barrel may include a special storage chamber within a coring tool for holding the core specimen. Furthermore, the core catcher may provide a grip to the bottom of a core and, as tension is applied to the drill string, the rock under the core breaks away from the undrilled formation below coring tool. Thus, the core catcher may retain the core specimen to avoid the core specimen falling through the bottom of the drill string.

Keeping with FIG. 1, geosteering may be used to position the drill bit or drill string of the drilling system (110) relative to a boundary between different subsurface layers (e.g., overlying, underlying, and lateral layers of a pay zone) during drilling operations. In particular, a control system (114) may communicate geosteering commands to the drilling system (110) based on well log data updates that are further adjusted by the reservoir simulator (160). As such, the control system (114) may generate one or more control signals for drilling equipment (or a logging system may generate for logging equipment) based on an updated well path design. As such, a geosteering system may use various sensors located inside or adjacent to the drill string to determine different rock formations within a well path. In some geosteering systems, drilling tools may use resistivity or acoustic measurements to guide the drill bit during horizontal or lateral drilling.

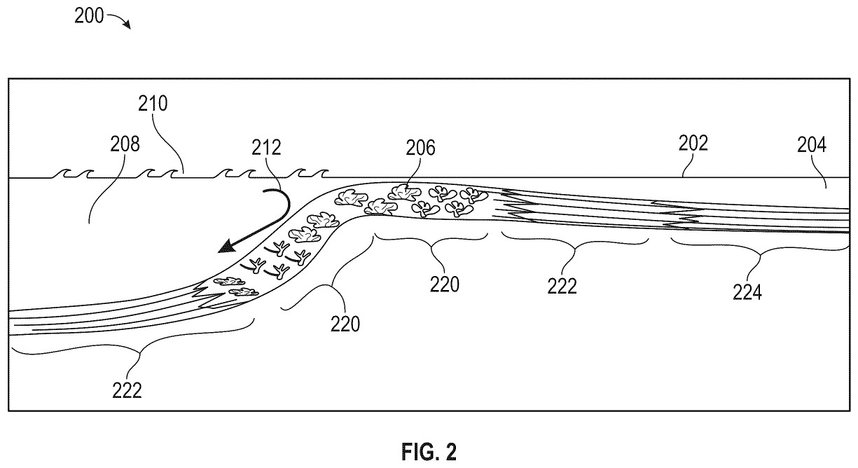

Turning to FIG. 2, FIG. 2 depicts a didactic representation of a typical carbonate depositional environment (200). The environment includes a sea surface (202) that may extend from a shallow lagoon (204) over the crest of a reef (206) to a deeper forereef zone (208). The reef (206) may be composed of living and skeletal coral. The energy of ocean waves (210) and currents (212) on the forereef (208) side of the reef (206) may be much greater than the waves and currents in the lagoon (204). The bulk of the sedimentary deposits accumulating in such a carbonate depositional environment (200) may be generated by the growth of corals on the reef (206). The reef (206) crest is the location of the most robust coral growth. Coral growth and wave action along the reef crest and proximate zones, commonly result in carbonate facies such as boundstone, floatstone, bafflestone, framestone, and bindstone (220). These stones (220), for example boundstone, may be composed of constituents that are too large to be transported even by energetic ocean waves (210) and ocean currents (212). Successive generations of coral may bury and grow on top of these stones (220), particularly during geological periods of sea-level rise or regional tectonic subsidence. In the lagoon (204), where the energy of waves and currents are low, smaller grains (sand) may be transported and deposited in a narrow sand apron to form carbonate facies such as grainstone and floatstone (222). At greater distances from the reef (206) into the lagoon (204) still smaller and more easily transported grains may be deposited to form the carbonate facies of packstone, wackestone, and mudstone (224). On the forereef (208) side of the reef (206), the high energy ocean waves (210) and ocean currents (212) may carry sand grains further from the reef over a broader zone stretching from the reef (206) into the deeper ocean resulting in the carbonate facies of grainstone or rudstone (222).

Furthermore, the classification of carbonate rocks may be done with a classification system such as the Dunham classification system. The Dunham classification system categorizes a carbonate rock based on characteristics such as texture, constituents present, and size of constituents. The Dunham classification system, relating carbonate rock characteristics to a carbonate facies, is summarized in Table 1.

| Carbonate | |
|---|---|
| Facies | Characteristics |
| Mudstone | Constituents not bound during deposition |
| | Contains carbonate mud |
| | Is mud supported |
| | Less than 10% grains |
| Wackestone | Constituents not bound during deposition |
| | Contains carbonate mud |
| | Is mud supported |
| | More than 10% grains |
| | Small grains (on the scale of millimeters) |
| Floatstone | Constituents not bound during deposition |
| | Contains carbonate mud |
| | Is mud supported |
| | More than 10% grains |
| | Large grains (on the scale of tens of millimeters) |
| Packstone | Constituents not bound during deposition |
| | Contains carbonate mud |
| | Is grain supported |
| | Small grains (on the scale of millimeters) |
| Grainstone | Constituents not bound during deposition |
| | Does not contain carbonate mud |
| | Is grain supported |
| | Small grains (on the scale of millimeters) |
| Rudstone | Constituents not bound during deposition |
| | May be mud or grain supported |
| | Large grains (on the scale of tens of millimeters) |
| Boundstone | Constituents bound during deposition |
| | Small constituents (on the scale of millimeters) |
| Framestone | Constituents bound during deposition |
| | Very large constituents (on the scale of meters) |
| Bindstone | Constituents bound during deposition |
| | Large constituents (on the scale of hundreds of millimeters) |
| | Layered structure |
| Bafflestone | Constituents bound during deposition |
| | Large constituents (on the scale of hundreds of millimeters) |

The various facies of the subsurface formations often reflect the conditions under which they were formed. That is different geological processes and environments produce different facies.

As described, subsurface formation properties may be used to identify reservoir locations and characterize reservoirs, including estimating reservoir quality. As such, an accurate subsurface model is critical to reduce exploration risks, improve reservoir characterization, best leverage existing discoveries, and better extend hydrocarbon recovery from existing wells. One type of subsurface model is a depositional model. Depositional models, broadly defined, are process-based models which seek to reproduce the geological time evolution of a geographic region. Depositional models are powerful because depositional sequences directly correlate to subsurface formation properties, as shown in FIG. 2. Additionally, depositional processes affect reservoir architecture, govern fluid flow, and may define stratigraphic compartments.

However, in addition to depositional processes, reservoir quality is greatly affected by syn-depositional and post-depositional processes. Broadly defined, diagenesis encompasses modifications that affect the sediment during and after burial. Examples of diagenetic processes are, but not limited to, compaction and cementation. Diagenetic processes may alter, or even control, the distribution of porosity in the subsurface formations. Diagenetic processes are typically considered through modeling efforts that are separate and disjoint from depositional models. These syn-depositional and post-depositional models can be summarized as diagenetic modeling.

In particular, carbonates, as opposed to clastic rocks, are much more susceptible to post-depositional alteration. For carbonates, diagenesis occurs very quickly after deposition. For carbonate rocks, deposition and diagenesis often work concurrently. Diagenesis may follow a template established at the time of deposition. Moreover, post-depositional processes, such as meteoric diagenesis, dissolution, karsting, build-up of carbonates, etc. may alter topography and affect the depositional processes. Consequently, interactions between depositional processes and diagenesis should be considered to improve reservoir characterization. Approaches to coupling depositional models and diagenetic models are either non-existent or hotly debated and there is currently no single modeling software that allows for full integration of depositional and diagenetic processes in the subsurface model.

In one aspect, embodiments disclosed herein relate to a method of updating a facies model within a depositional model with cementation information using empirical relationships between specific carbonate facies, cementation distribution and wave energy or fluid velocity. By updating the facies model with cementation, diagenetic processes are integrated into the depositional model. The result is an improved subsurface model which provides quantitative, three-dimensional (3D) information on reservoir architecture, internal lithofacies heterogeneity, and reservoir quality indicators like porosity and permeability.

One with ordinary skill in the art will recognize that there are many depositional modelling software applications, or applications with depositional modelling capabilities, such as SEDSIM and DIONISOSFLOW. Further, one with ordinary skill in the art will appreciate that the methods and systems of the instant disclosure are not limited by the choice of the depositional model implementation. When employing a depositional model, wave energies may be considered an output, or at least an intermediate result, of the depositional model. In some implementations, fluid velocity may be determined using a depositional model. However, in instances where fluid velocity is desired but not immediately produced it may be determined using the relationship C=C₀\sqrt{h/h₀}, where C is the fluid energy as a function of water depth, h. The previous relationship is based on the Airy wave theory and is parameterized by the height of the ocean surface, h₀, and the corresponding maximal tidal current near the ocean surface, C₀.

In accordance with one or more embodiments, a diagenetic model for cementation is incorporated into a forward depositional model with a spatial distribution of carbonate facies through an empirical function relating cementation to wave energy and carbonate facies. To understand the empirical function, one should note that the factors governing cementation rate, as currently understood, may be broadly classified into two groups: the reaction kinetics of the carbonate cement mineral, or calcite; and the transport of chemical solutes. Typically, calcite precipitation is quite fast relative to the transport of chemical species such that chemical species transport is the rate-limiting factor in cementation. The transport rate of chemical species and solutes is directly related to the velocity of the fluid which carries said chemical species and solutes. Additionally, in accordance with one or more embodiments, the fluid velocity and wave energy may be linearly correlated using the following equation:

$$wave energy ( \frac{k W}{m} ) = 10 \; 3.3119 ( \frac{k W s}{{m}^{2}} ) fluid velocity ( \frac{m}{s} ) . \qquad ( 1 )$$

In other embodiments, different functional relationships between wave energy and fluid velocity may be used. As such, if the depositional model produces fluid velocity, or if fluid velocity is otherwise acquired, wave energy may be determined. However, as previously stated, depositional models are more likely to produce wave energy. Consequently, cementation may be empirically related to wave energy.

The functional relationship between cementation and wave energy is of the form

$$cementation ( \% ) = A {( wave energy ( \frac{k W}{m} ) )}^{n} , \qquad ( 2 )$$

where A is a pre-factor and n is an exponent. The units of the pre-factor A are specific to the exponent n to account for the conversion from

$${( \frac{k W}{m} )}^{n}$$

to a percentage. That is, the units of the pre-factor A are

$${( \frac{m}{k W} )}^{n} .$$

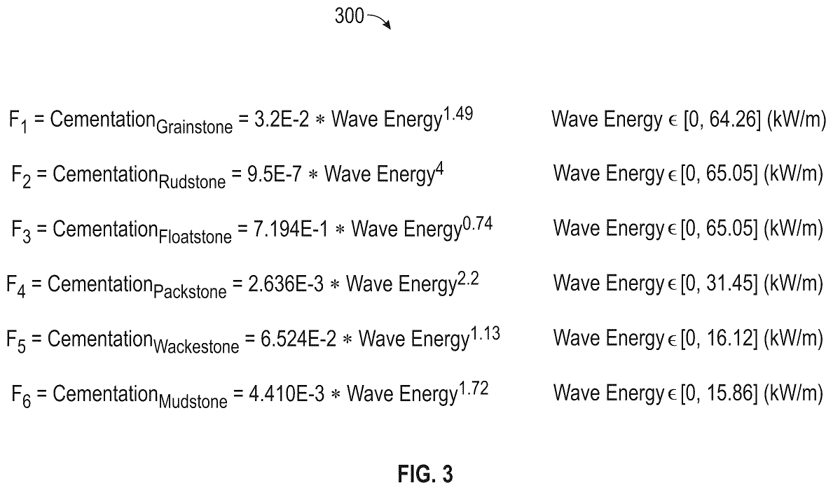

The pre-factor A and exponent n are different for each carbonate facies. The pre-factor A and exponent n have been determined for a select number of carbonate facies by fitting the functional relationship given by EQ. 2 to cementation abundance data collected through petrographic studies plotted according to the expected wave energy given the physical location of the collected data. The determined pre-factors and exponents are provided in Table 1 according to carbonate facies. Additionally, the functional relationship given by EQ. 2 is written out for each of the select carbonate facies in Table 1 in FIG. 3.

TABLE 1
Pre-factors and exponents for use in equation
2 according to carbonate facies.

| Carbonate Facies | Pre-factor | Exponent | Domain |
|---|---|---|---|
| Grainstone | 3.200E−2 | 1.49 | [0, 64.26] |
| Rudstone | 9.500E−1 | 4.00 | [0, 65.05] |
| Floatstone | 7.194E−1 | 0.74 | [0, 65.05] |
| Packstone | 2.636E−3 | 2.20 | [0, 31.45] |
| Wackestone | 6.524E−2 | 1.13 | [0, 16.12] |
| Mudstone | 4.410E−3 | 1.72 | [0, 15.86] |

It should be noted that the fitted parameters, the pre-factor A and exponent n, of EQ. 2 for the mentioned carbonate facies were fitted over a range of wave energies, also known as the function domain. The domain of the fit for each carbonate facies is provided in Table 1. Extrapolation using EQ. 2 with the associated parameters for a given carbonate facies outside of the domain should only be done with caution or with additional validation and/or calibration of the parameters.

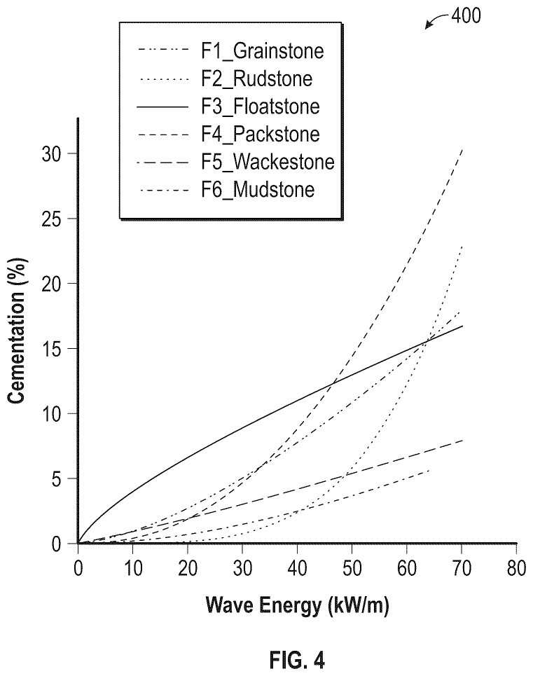

With the fitted parameters, EQ. 2 forms empirical relationship between percent cementation and wave energy, as determined by the depositional model, and carbonate facies. FIG. 4 shows the empirical relationships, one for each of the carbonate facies with fitted parameters, graphically.

To summarize, in accordance with one or more embodiments, a subsurface model which incorporates both depositional processes and diagenetic processes may be constructed by integrating cementation abundance information into a depositional model via an empirically-derived function relating cementation abundance to quantities calculated and accessible to the depositional model. More specifically, the depositional model may be capable of determining carbonate facies and wave energy or fluid velocity. The wave energy, or fluid velocity, at a spatial point may be passed through the empirically derived function according to the carbonate facies at that spatial point to determine percent cementation at that spatial point. The facies model may be updated with the calculated cementation to form an improved facies-cement model. The depositional model may iteratively model sediment deposition, bathymetry, and facies-cement distributions to produce a three-dimensional (3D), time-evolving, quantitative subsurface model. In addition to understanding and visualizing reservoir architecture and internal lithofacies heterogeneity, the improved facies-cement model allows for a more accurate determination of porosity-which is a critical reservoir quality indicator. This is because the updated porosity in the subsurface formations may be defined as

$$updated porosity ( \% ) = original porosity ( \% ) - cementation ( \% ) . \qquad ( 3 )$$

The process of updating the facies model in a depositional model may include diagenetic information about cementation. A depositional model may be capable of modeling the spatial distribution of carbonate facies in the subsurface formations over a subsurface region of interest. The depositional model also includes information about, or can calculate or otherwise access, the spatial distribution of wave energies, either directly or indirectly, over the subsurface region of interest.

In some embodiments, a spatial distribution of cementation is determined, by determining a cementation for each spatial point in the subsurface region of interest based on the carbonate facies and wave energy at said spatial point. With an understanding of cementation in the subsurface region of interest, changes in reservoir properties may be determined based on the depositional model. For example, the change in porosity due to cementation may be calculated using EQ. 3. The facies model of the depositional model may be updated based on the spatial distribution of cementation to form a facies-cement model. Finally, reservoir production may be simulated in a reservoir simulator based, at least in part, on the facies-cement model to plan the location of future wells.

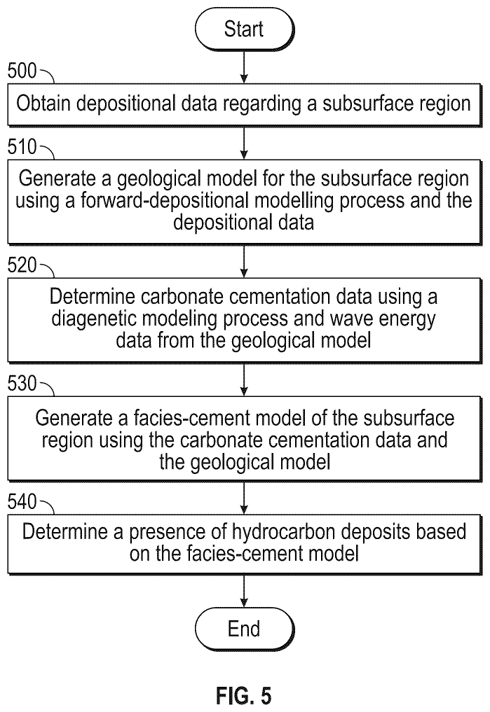

Turning to FIG. 5, FIG. 5 shows a flowchart in accordance with one or more embodiments. Specifically, FIG. 5 describes a general method for generating a facies-cement model based on forward-depositional modeling and diagenetic modeling. One or more blocks in FIG. 5 may be performed by one or more components (e.g., reservoir simulator (160)) as described in FIG. 1. While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 500, depositional data are obtained regarding a subsurface region in accordance with one or more embodiments. Depositional data may include initial bathymetry data, subsidence, history data, sea-level change data, sediment type data, carbonate production data, and wave impact data. In Block 510, a geological model is generated for a subsurface region using a forward-depositional modeling process and the depositional data. The geological model will include wave energy data and facies model data. The facies model data identifies facies in the subsurface region. The wave energy data is the spatial distribution of wave energies over the subsurface region. In Block 520, carbonate cementation data is determined using a diagenetic modeling process and wave energy data from the geological model. Specifically, the wave energy at a location is processed by Equation 2 with a pre-factor and exponent chosen according to the facies to determine the carbonate cementation at that location. Examples of appropriate pre-factors and exponents for various facies are shown in Table I. In Block 530, a facies-cement model of the subsurface region is generated using carbonate cementation data and the geological model generated in block 510. The facies-cement model incorporates the carbonate cementation data with the various facies in the subsurface region. In Block 540, a presence of hydrocarbon deposits is determined based on a facies-cement model. For example, Equation 3 may be used to better estimate the porosity of the subsurface region given the facies-cement model. Porosity is a key indicator of hydrocarbon storage capacity.

In some embodiments, the facies-cement model is used by a reservoir simulator to predict reservoir production data. Likewise, the facies-cement model may be used by one or more control systems to determine geosteering commands for drilling a well path in a subsurface region.

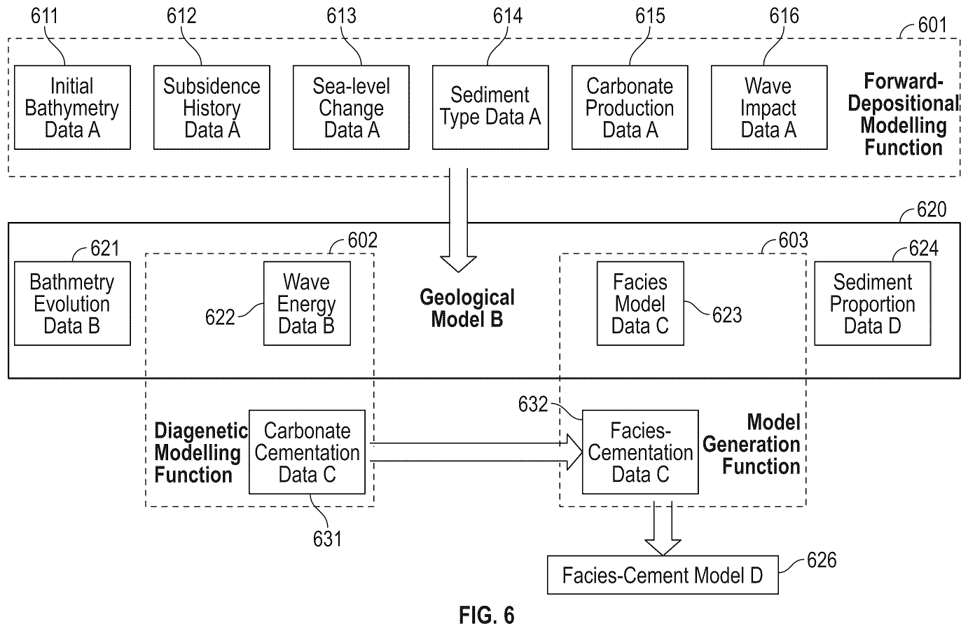

Turning to FIG. 6, FIG. 6 illustrates an example for determining a facies-cement model using wave energy in accordance with one or more embodiments. The following example is for explanatory purposes only and not intended to limit the scope of the disclosed technology. In FIG. 6, a reservoir simulator (not shown) obtains various depositional data (i.e., initial bathymetry data A (611), subsidence history data A (612), sea-level change data A (613), sediment type data A (614), carbonate production data A (615), and wave impact data A (616)). Additional data, beyond what is listed above, may include parameterization data for the depositional model, such as transport parameters and the simulation time step. Depositional data, such as the sea-level change data A (613) may be acquired from literature studies. Other depositional data may be estimated or determined from seismic surveys and petrophysical logs.

Using a forward-depositional modeling function (601), the reservoir simulator determines a geological model B (620) that includes bathymetry evolution B (621), wave energy data B (622), facies model data C (623), and sediment proportion data D (624).

As such, the reservoir simulator uses the wave energy data B (622) from the geological model B (620) and facies model data C (623) as inputs to a diagenetic modeling function (602) to produce carbonate cementation data C (631). Likewise, the reservoir simulator combines the preliminary facies model data C (623) and the carbonate cementation data C (631) with a model generation function (603) to produce facies-cementation data C (632). The facies-cementation data C (632) may be used to construct a facies-cement model D (626) of the subsurface region, wherein the facies-cement model D (626) comprises, at least, a visualization of the facies-cementation data C (632).

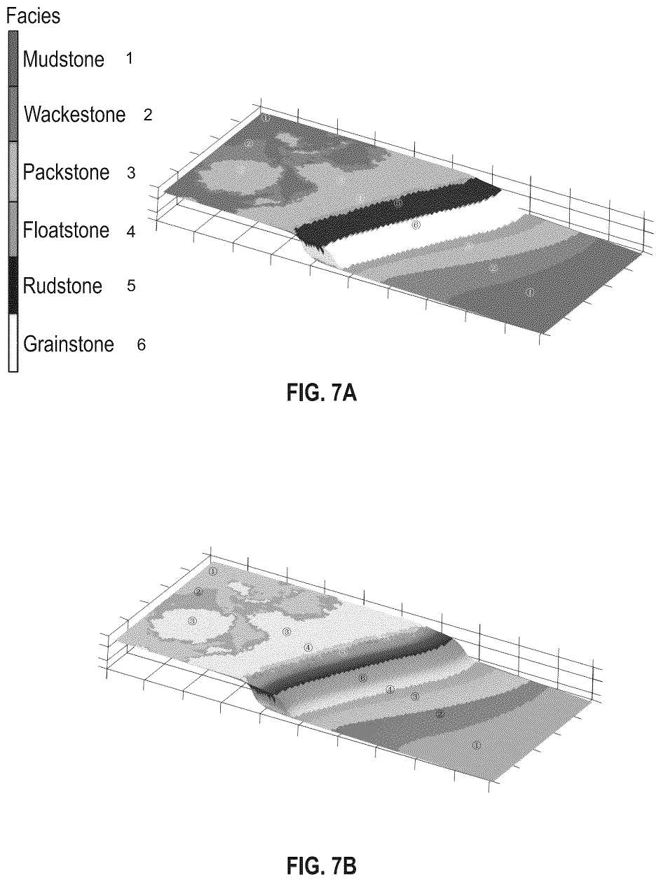

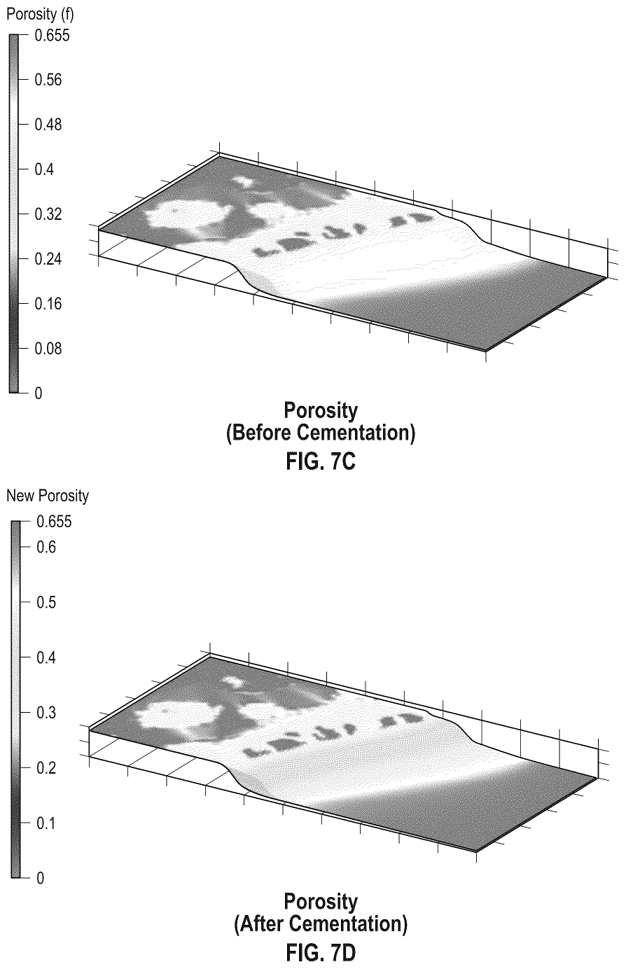

Turning to FIGS. 7A, 7B, 7C, and 7D, comparisons of the subsurface model with and without the integration of cementation modeling processes are shown. More specifically, FIG. 7A shows a resultant facies model without cementation; otherwise known as the facies model data C (632). FIG. 7B depicts an improved facies-cement model, or the facies-cement model D (626), which maps the spatial distribution of cementation in addition to the carbonate facies. FIG. 7B displays both carbonate facies and percent cementation by superimposing a saturation, where the grade of saturation indicates percent cementation, on a discrete color, where the discrete color describes carbonate facies. To aid in viewing FIGS. 7A and 7B, a numeric label has been provided along with each discrete color.

Additionally, FIG. 7C shows the map of porosity, a key reservoir quality indicator, using the subsurface model with only deposition and without integrating the spatial distribution of cementation. By integrating the spatial distribution of cementation (facies-cementation data C (632)) into the depositional model, changes in reservoir properties may be determined. FIG. 7D displays the updated facies model, which takes into account the changes in reservoir properties, and demonstrates a significant change in the modeled porosity.

Embodiments may be implemented on a computer system. FIG. 8 is a block diagram of a computer system (802) used to provide computational functionalities associated with described algorithms, methods, functions, processes, flows, and procedures as described in the instant disclosure, according to an implementation. The illustrated computer (802) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (802) may include a computer that includes an input device, such as a keypad, keyboard, touch screen, or other device that can accept user information, and an output device that conveys information associated with the operation of the computer (802), including digital data, visual, or audio information (or a combination of information), or a GUI.

The computer (802) can serve in a role as a client, network component, a server, a database or other persistency, or any other component (or a combination of roles) of a computer system for performing the subject matter described in the instant disclosure. The illustrated computer (802) is communicably coupled with a network (830). In some implementations, one or more components of the computer (802) may be configured to operate within environments, including cloud-computing-based, local, global, or other environment (or a combination of environments).

At a high level, the computer (802) is an electronic computing device operable to receive, transmit, process, store, or manage data and information associated with the described subject matter. According to some implementations, the computer (802) may also include or be communicably coupled with an application server, e-mail server, web server, caching server, streaming data server, business intelligence (BI) server, or other server (or a combination of servers).

The computer (802) can receive requests over network (830) from a client application (for example, executing on another computer (802)) and responding to the received requests by processing the said requests in an appropriate software application. In addition, requests may also be sent to the computer (802) from internal users (for example, from a command console or by other appropriate access method), external or third-parties, other automated applications, as well as any other appropriate entities, individuals, systems, or computers.

Each of the components of the computer (802) can communicate using a system bus (803). In some implementations, any or all of the components of the computer (802), both hardware or software (or a combination of hardware and software), may interface with each other or the interface (804) (or a combination of both) over the system bus (803) using an application programming interface (API) (812) or a service layer (813) (or a combination of the API (812) and service layer (813). The API (812) may include specifications for routines, data structures, and object classes. The API (812) may be either computer-language independent or dependent and refer to a complete interface, a single function, or even a set of APIs. The service layer (813) provides software services to the computer (802) or other components (whether or not illustrated) that are communicably coupled to the computer (802). The functionality of the computer (802) may be accessible for all service consumers using this service layer. Software services, such as those provided by the service layer (813), provide reusable, defined business functionalities through a defined interface. For example, the interface may be software written in JAVA, C++, or other suitable language providing data in extensible markup language (XML) format or another suitable format. While illustrated as an integrated component of the computer (802), alternative implementations may illustrate the API (812) or the service layer (813) as stand-alone components in relation to other components of the computer (802) or other components (whether or not illustrated) that are communicably coupled to the computer (802). Moreover, any or all parts of the API (812) or the service layer (813) may be implemented as child or sub-modules of another software module, enterprise application, or hardware module without departing from the scope of this disclosure.

The computer (802) includes an interface (804). Although illustrated as a single interface (804) in FIG. 8, two or more interfaces (804) may be used according to particular needs, desires, or particular implementations of the computer (802). The interface (804) is used by the computer (802) for communicating with other systems in a distributed environment that are connected to the network (830). Generally, the interface (804 includes logic encoded in software or hardware (or a combination of software and hardware) and operable to communicate with the network (830). More specifically, the interface (804) may include software supporting one or more communication protocols associated with communications such that the network (830) or interface's hardware is operable to communicate physical signals within and outside of the illustrated computer (802).

The computer (802) includes at least one computer processor (805). Although illustrated as a single computer processor (805) in FIG. 8, two or more processors may be used according to particular needs, desires, or particular implementations of the computer (802). Generally, the computer processor (805) executes instructions and manipulates data to perform the operations of the computer (802) and any algorithms, methods, functions, processes, flows, and procedures as described in the instant disclosure.

The computer (802) also includes a memory (806) that holds data for the computer (802) or other components (or a combination of both) that can be connected to the network (830). For example, memory (806) can be a database storing data consistent with this disclosure. Although illustrated as a single memory (806) in FIG. 8, two or more memories may be used according to particular needs, desires, or particular implementations of the computer (802) and the described functionality. While memory (806) is illustrated as an integral component of the computer (802), in alternative implementations, memory (806) can be external to the computer (802).

The application (807) is an algorithmic software engine providing functionality according to particular needs, desires, or particular implementations of the computer (802), particularly with respect to functionality described in this disclosure. For example, application (807) can serve as one or more components, modules, applications, etc. Further, although illustrated as a single application (807), the application (807) may be implemented as multiple applications (807) on the computer (802). In addition, although illustrated as integral to the computer (802), in alternative implementations, the application (807) can be external to the computer (802).

There may be any number of computers (802) associated with, or external to, a computer system containing computer (802), each computer (802) communicating over network (830). Further, the term “client,” “user,” and other appropriate terminology may be used interchangeably as appropriate without departing from the scope of this disclosure. Moreover, this disclosure contemplates that many users may use one computer (802), or that one user may use multiple computers (802).

In some embodiments, the computer (802) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. In the claims, any means-plus-function clauses are intended to cover the structures described herein as performing the recited function(s) and equivalents of those structures. Similarly, any step-plus-function clauses in the claims are intended to cover the acts described here as performing the recited function(s) and equivalents of those acts. It is the express intention of the applicant not to invoke 35 U.S.C. § 112(f) for any limitations of any of the claims herein, except for those in which the claim expressly uses the words “means for” or “step for” together with an associated function.

What is claimed is:

1. A method, comprising:
obtaining depositional data regarding a subsurface region, wherein the depositional data comprises wave impact data;
generating, by a computer processor, a geological model for the subsurface region using a forward-depositional modeling process and the depositional data, wherein the geological model comprises wave energy data;
determining, by the computer processor, carbonate cementation data for the subsurface region using a diagenetic modeling process and the wave energy data, wherein the carbonate cementation data describes cementation in one or more depositional processes; and
generating, by the computer processor, a facies-cement model of the subsurface region.

2. The method of claim 1, further comprising determining a presence of hydrocarbons in the subsurface region using the facies-cement model.

3. The method of claim 1, wherein the wave energy data is converted into a cementation abundance distribution within the subsurface to generate the facies-cement model.

4. The method of claim 1, wherein at least a portion of the carbonate cementation data describes a cementation rate of one or more sedimentary deposits in the subsurface region.

5. The method of claim 1, further comprising determining a geosteering command for a drilling system based on the facies-cement model.

6. The method of claim 1, wherein the depositional data further comprise bathymetry data, subsidence history data, sediment type data, and carbonate production data.

7. The method of claim 1, wherein the geological model comprises a facies model, sediment proportion data, and bathymetry evolution data.

8. A system, comprising:
a plurality of wells coupled to a subsurface region; and
a reservoir simulator comprising a computer processor and coupled to the plurality of wells, wherein the reservoir simulator comprises functionality for:
obtaining depositional data regarding the subsurface region, wherein the depositional data comprises wave impact data;
generating a geological model for the subsurface region using a forward-depositional modeling process and the depositional data, wherein the geological model comprises wave energy data;
determining carbonate cementation data for the subsurface region using a diagenetic modeling process and the wave energy data, wherein the carbonate cementation data describes cementation in one or more depositional processes; and
generating a facies-cement model of the subsurface region.

9. The system of claim 8, wherein the reservoir simulator further comprises functionality for determining a presence of hydrocarbons in the subsurface region using the facies-cement model.

10. The system of claim 8, wherein the wave energy data is converted into a cementation abundance distribution within the subsurface to generate the facies-cement model.

11. The system of claim 8, wherein at least a portion of the carbonate cementation data describes a cementation rate of one or more sedimentary deposits in the subsurface region.

12. The system of claim 8, further comprising a control system, wherein the control system comprises functionality for determining a geosteering command for a drilling system based on the facies-cement model.

13. The system of claim 8, wherein the depositional data further comprise bathymetry data, subsidence history data, sediment type data, and carbonate production data.

14. The system of claim 8, wherein the geological model comprises a facies model, sediment proportion data, and bathymetry evolution data.

15. A non-transitory computer readable medium storing instructions executable by a computer processor, the instructions comprising functionality for:
obtaining depositional data regarding a subsurface region, wherein the depositional data comprises wave impact data;
generating a geological model for the subsurface region using a forward-depositional modeling process and the depositional data, wherein the geological model comprises wave energy data;
determining carbonate cementation data for the subsurface region using a diagenetic modeling process and the wave energy data, wherein the carbonate cementation data describes cementation in one or more depositional processes; and
generating a facies-cement model of the subsurface region.

16. The non-transitory computer readable medium of claim 15, wherein the wave energy data is converted into a cementation abundance distribution within the subsurface to generate the facies-cement model.

17. The non-transitory computer readable medium of claim 15, wherein at least a portion of the carbonate cementation data describes a cementation rate of one or more sedimentary deposits in the subsurface region.

18. The non-transitory computer readable medium of claim 15, wherein the instructions further comprise functionality for determining a geosteering command for a drilling system based on the facies-cement model.

19. The non-transitory computer readable medium of claim 15, wherein the depositional data further comprise bathymetry data, subsidence history data, sediment type data, and carbonate production data.

20. The non-transitory computer readable medium of claim 15, wherein the geological model comprises a facies model, sediment proportion data, and bathymetry evolution data.
